(19) United States
(12) Patent Application Publication
(10) Pub. No.: US 2014/0337231 A1
(43) Pub. Date: Nov. 13, 2014

(54) DEPILATION DEVICE

(71) Applicant: Limor ROZEN, RamatSharon (IL)

(72) Inventor: Limor Rozen, Ramat Hasharon (IL)

(21) Appl. No.: 14/362,404

(22) PCT Filed: Dec. 4, 2012
(86) PCT No.: PCT/IB2012/056944

§ 371 Date: Jun. 3, 2014

Related U.S. Application Data
(60) Provisional application No. 61/630,099, filed on Dec. 5, 2011.

(51) Int. Cl. G06Q 20/22

(52) U.S. Cl. CPC G06Q 20/22
USPC 705/44

(57) ABSTRACT

A method of pre-allocating amounts for payment transactions comprising: receiving by a payment service server a registration request to the service from a user's communication device, the registration request comprising information related to the user's payment means; allocating by the payment service a user ID to the user's communication device; receiving by the payment service server a request for allocating a sum of money from the user's communication device, the request comprising the user ID; checking by the payment service server if the sum may be allocated to the user; allocating by the payment service server the sum of money to the user; and sending by the payment service server a session ID to the user.

### CROSS-REFERENCE TO RELATED PATENT APPLICATIONS

This patent application claims priority from and is related to U.S. Provisional Patent Application Ser. No. 61/630,099, filed 5 Dec. 2011, entitled: SYSTEM AND METHOD FOR PRE-ALLOCATION OF TRANSACTION AMOUNT, this U.S. Provisional Patent Application incorporated by reference in its entirety herein.

### FIELD OF THE INVENTION

The present invention is in the field of payment and monetary transaction and more specifically transactions pre-confirmed by a designated service.

### BACKGROUND

FIG. 1 shows some important elements in the current process of performing a purchase using a credit card or equivalent (e.g. chargeable card) as a payment mean.

The buyer 100 provides 101 his credit card/payment info to the seller 110, the seller 110 request approval 102 for the transaction from the payment company (e.g. credit card issuer, credit card processor, or other payment facilitator), the payment company issues an approval 103 to the seller and the transaction is accomplished.

This prevailing process requires the purchaser to physically present his payment means to the seller, or to communicate to the seller, over the telephone or over the internet, private information such as credit card number.

### SUMMARY OF THE INVENTION

According to an aspect of the present invention there is provided a method of pre-allocating amounts for payment transactions comprising: receiving by a payment service server a registration request to said service from a user's communication device, said registration request comprising information related to said user's payment means; allocating by said payment service a user ID to said user's communication device; receiving by said payment service server a request for allocating a sum of money from said user's communication device, said request comprising said user ID; checking by said payment service server if the sum may be allocated to the user; allocating by said payment service server the sum of money to the user; and sending by said payment service server a session ID to the user.

The request for allocating may comprise a seller ID.

He request for allocating may comprises a time limit.

The request for allocating may comprise an indication of whether said sum of money is maximum or substantially fixed.

The request for allocating may comprise a location range.

The user ID may comprise a PIN.

The user ID may comprise biometric identification.

According to another aspect of the present invention there is provided a method of selling, comprising: receiving by a seller a session ID from a buyer's communication device, said session ID representing at least a sum of money; requesting by said seller confirmation for said session ID from a payment service's server, said request comprising at least said sum of money; and receiving by said seller said confirmation from said payment service's server.

The session ID may comprise a seller ID.

The session ID may comprise a time limit.

The session ID may comprise an indication of whether said sum of money is maximum or substantially fixed.

The method may additionally comprise receiving by said seller a user ID from said buyer and wherein said requesting confirmation additionally comprises said user ID.

The user ID may comprise a PIN.

The user ID may comprise biometric identification.

The method may additionally comprise receiving a location range from said buyer and wherein said requesting confirmation additionally comprises said location range.

According to another aspect of the present invention there is provided a method of purchasing, comprising: sending by a user's communication device a registration request to a payment service server, said registration request comprising information related to said user's payment means; allocating by said payment service's server a user ID to said user's communication device; sending by said user's communication device to said payment service server a request for allocating a sum of money, said request comprising said user ID; receiving by said user's communication device a confirmation for said allocation request, said confirmation comprising a session ID representing at least a sum of money; supplying said session ID to a seller; requesting by said seller confirmation for said session ID from said payment service server, said request comprising at least a sum of money and an ID of said seller; and receiving by said seller from said payment service server said confirmation.

The session ID may comprise a seller ID.

The session ID may comprise a time limit.

The session ID may comprise an indication of whether said sum of money is maximum or substantially fixed.

The user ID may comprise a PIN.

The user ID may comprise biometric identification.

The method may additionally comprise supplying a location range to said seller.

According to another aspect of the present invention there is provided a system for pre-allocating amounts for payment transactions comprising; a payment service company comprising: a service server; first communication means configured to receive a registration request from at least one user, said registration request comprising information related to said user's payment means; said server configured to allocate a user ID to said at least one user; said first communication means further configured for receiving a request for allocation of a sum of money from a user and for transmitting a confirmation to said user, including a session ID; at least one user comprising second communication means configured to communicate said request for registration and said request for allocating a sum of money to said payment company; and at least one seller comprising third communication means configured to communicate said session ID and at least a sum of money to said payment service server; said first communication means additionally configured to communicate a confirmation to said seller.

The first and third communication means may comprise at least one of a computer, a line telephone and a cellular phone.

The second communication means may comprise at least one of a computer/terminal/POS, a line telephone and a cellular phone.

The at least one of said first, second and third communication means may be line communication means.

The at least one of said first, second and third communication means may be wireless communication means.

The third communication means may additionally be configured to communicate at least one of a user ID and a location range to said payment company.

The user ID may comprise a PIN.

The user ID may comprise biometric identification.

According to another aspect of the present invention there is provided a method of authorizing payment transactions comprising: receiving by a payment service server a registration request to said service from a user's communication device, said registration request comprising information related to said user's payment means; allocating by said payment service a user ID to said user's communication device; receiving by said payment service server a transaction confirmation request from said user's communication device, said transaction confirmation request comprising said user ID and at least a sum of money; checking by said payment service server if the sum may be allocated to the user; and sending by said payment service server a confirmation code to said user's communication device.

The user ID may comprise a PIN.

The user ID may comprise biometric identification.

According to another aspect of the present invention there is provided a method of selling, comprising: receiving by a seller a user ID from a buyer's communication device; requesting by said seller confirmation for said user ID from a payment service's server, said request comprising at least a sum of money; and receiving by said seller said confirmation from said payment service's server.

The user ID may comprise a PIN.

The user ID may comprise biometric identification.

According to another aspect of the present invention there is provided a method of purchasing, comprising: sending by a user's communication device a registration request to a payment service server, said registration request comprising information related to said user's payment means; allocating by said payment service's server a user ID to said user's communication device; sending by said user's communication device to said payment service server a request for allocating a sum of money, said request comprising said user ID; receiving by said user's communication device a confirmation for said allocation request, said confirmation comprising a confirmation code; and providing said confirmation code to a seller.

The user ID may comprise a PIN.

The user ID may comprise biometric identification.

According to another aspect of the present invention there is provided a system for authorizing payment transactions comprising: a payment service company comprising: a service server; first communication means configured to receive a registration request from at least one user's communication device, said registration request comprising information related to said user's payment means; said server configured to allocate a user ID to said at least one user; and said user communication device running an application configured to communicate said user ID and at least a sum of money to said payment service server and receive a payment authorization.

The user ID may comprise a PIN.

The user ID may comprise biometric identification.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows some important elements in the current process;

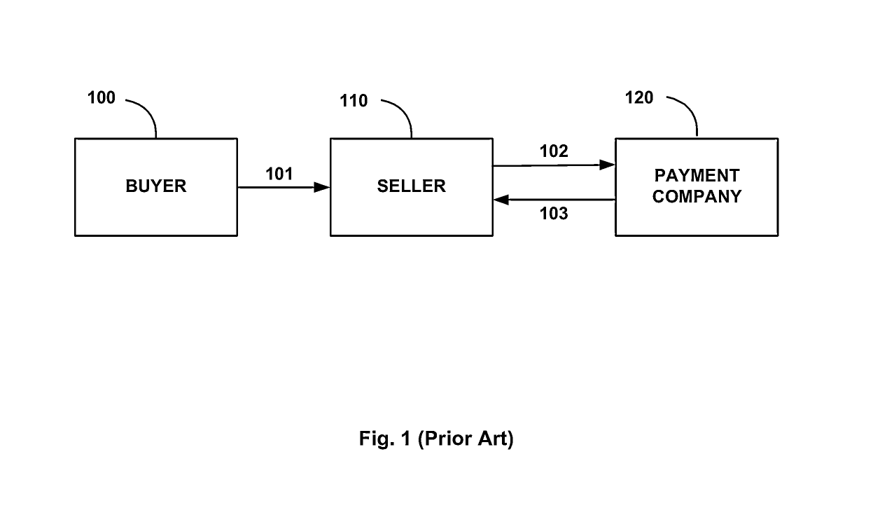

FIG. 2 shows the various connections of the payment enabling service according to the present invention;

FIG. 3 shows an exemplary system for carrying out the method according to the present invention;

FIG. 4 shows an embodiment of the new payment process 400 according to the present invention;

FIG. 5 is a flowchart showing the various steps taken by the user (buyer) according to an embodiment of the present invention; and

FIG. 6 is a flowchart showing the various steps taken by the service according to an embodiment of the present invention.

### DETAILED DESCRIPTION OF PREFERRED EMBODIMENTS

The present invention provides an alternative (or additional) systems and methods for carrying out monetary transactions.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

In general, embodiments of the invention can be implemented in any of a variety of hardware/software configurations. A particular embodiment includes at least one client computer and at least one server computer. The client(s) and server(s) may be executing on a common machine or may be deployed in distributed environment in which the client(s) and server(s) communicate via a network. However, the client-server model is merely one model in which the present invention may be implemented, and persons skilled in the art will recognize other possibilities. Furthermore, embodiments of the present invention can apply to any appropriate hardware configuration, regardless of whether the computer systems are complicated, multi-user computing apparatus, single-user workstations, network appliances that do not have non-volatile storage of their own or handheld devices such as personal digital assistants (PDAs), laptops, tablet computers and mobile telephones. Further, it is understood that while reference may be made to particular software products, the invention is not limited to a particular software product, standard or version nor to any particular programming language. Accordingly, persons skilled in the art will recognize that the invention is adaptable to other software products and that the invention is also adaptable to future versions of a particular software product as well as to other suitable software products presently unknown.

The method of the present invention, as incorporated in a computer program, may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The new methods enable purchase modes not currently available, such as enabling a person to perform secure purchases without having the physical credit card on him. This new method may enable a child to purchase goods authorized by his parents, without the need for the child to have the payment means such as credit card with him, and/or enable secure telephone or internet transactions by using additional safety measures. The new method may also serve for granting a third party a substantially fixed sum of money (possibly with the option to deviate to a prefixed percent) to be used anywhere, or at a specific seller, as a gift or a bonus.

These additional possibilities are enabled by a new payment enabling service, implemented as a web-application, or a native application downloaded to the user's mobile communication device (e.g. smartphone, tablet PC) and executed by the device processor. The payment enabling service according to the present invention communicates electronically with buyers (or potential buyers), sellers and payment companies (such as credit card issuer, credit card processor, bank issuing a debit card or other payment facilitator), as will be explained in detail below.

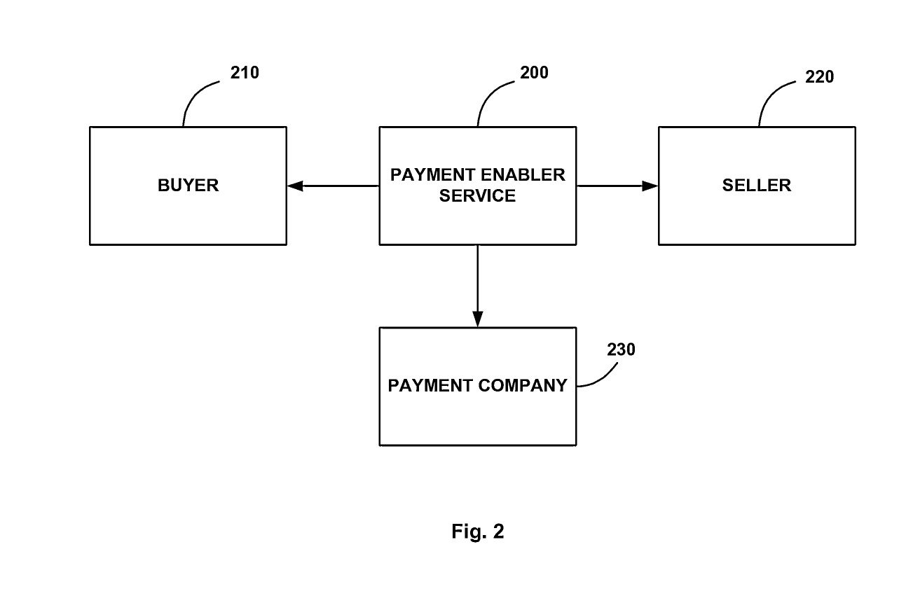

FIG. 2 shows the various connections of the payment enabling service 200 according to the present invention:

User 210—communicates with the service as follows:
a. Registration to the service—one time operation in which the user provides personal information (e.g. name, address, age, e-mail address), payment means (e.g. Credit card details, rechargeable card details), etc. Service may provide user with PIN code for future identification and/or request biometric identification means (e.g. voice signature).
b. Requesting/receiving money allocation.
c. Charging a rechargeable card;

Seller 220—communicates with the service as follows:
a. Registration to the service—optional one time operation in which the seller provides personal information (e.g. business name, business address, e-mail address, etc.). Service may provide seller with Seller ID for future identification.
b. Requesting/receiving transaction confirmation.

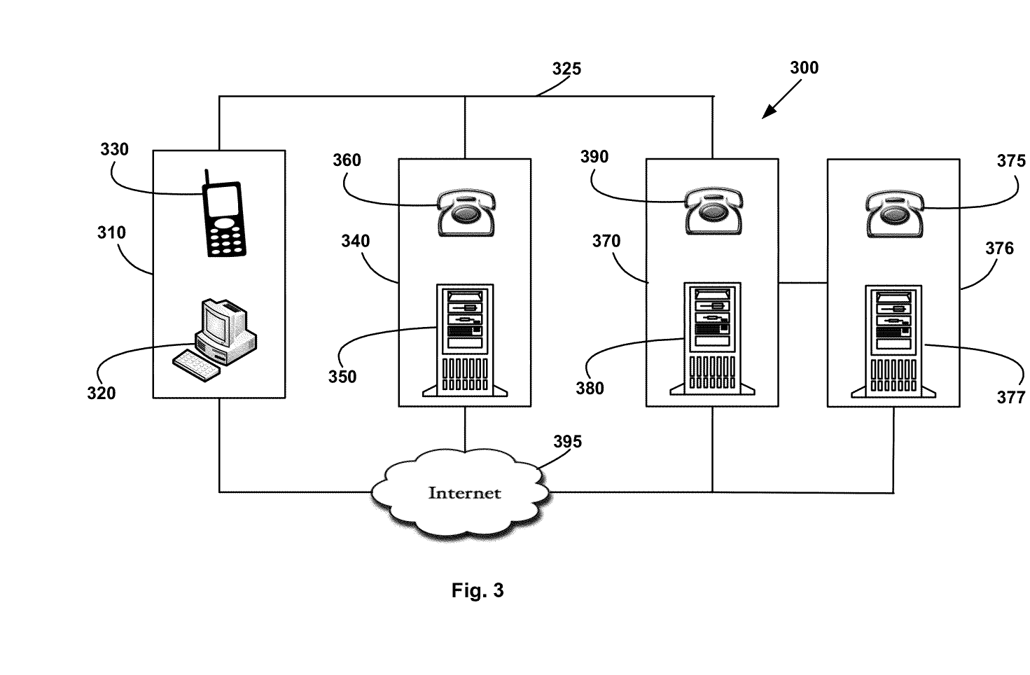

Payment company 230—communicates with the service as follows:
a. Authenticating user and credit card upon registration—one time operation;
b. Confirming/declining transaction.
An exemplary system 300 for carrying out the method according to the present invention is depicted schematically in FIG. 3.

The system 300 comprises an exemplary user 310, communicating with the service 370 e.g. for registration to the service, using the dedicated client application on his smartphone 330 or a web application on his PC 320 and optionally with a seller 340 using line or wireless communication means, such as the Internet 395, or his cellular phone 330, or a telephone line 325.

The seller 340 communicates with the service 370 and optionally with the user 310 using line or wireless communication means, such as the Internet 395, a cellular phone (not shown), or a telephone line 325 using his line telephone 360.

The service 370 communicates with the user 310 using the dedicated client application on the user's cellular phone 330 or a web application on the user's PC 320, with the seller 340 and with the payment company 376 using line or wireless communication means, such as the Internet 395, a telephone line 325 or a cellular phone (not shown).

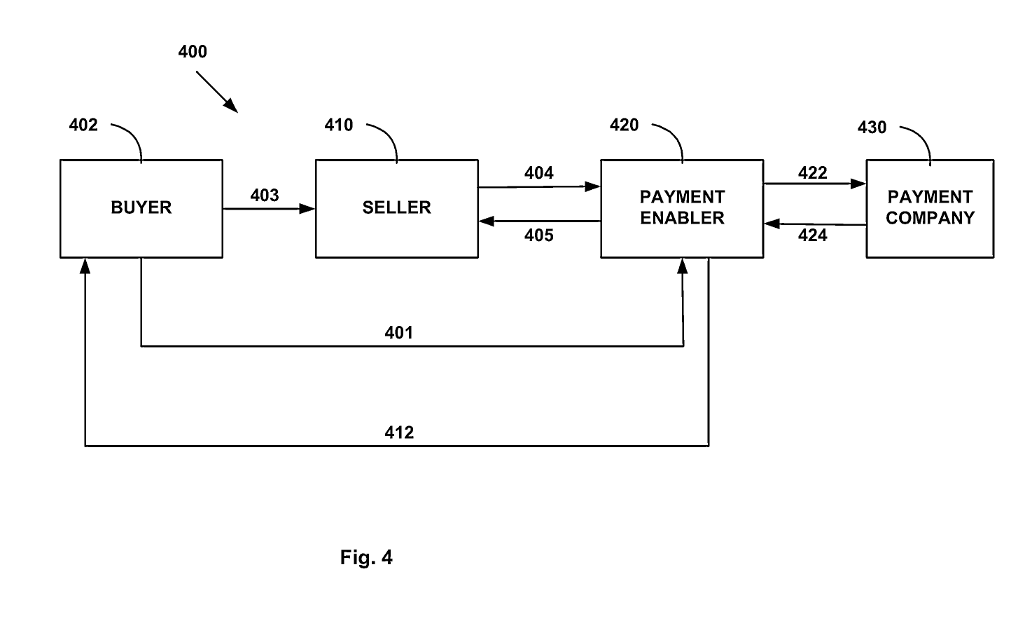

FIG. 4 shows an embodiment of the new payment process 400 according to the present invention.

The user (buyer) 402 requests 401 confirmation for one or more future transaction from the Payment Enabling Service 420.

The service 420 confirms 402 the transaction and sends the user a session ID to be used by the user for a specific requested transaction and/or a user ID for any non-specified future transaction.

The user 400, when wishing to use the service, provides 403 the seller 410 with the session ID and/or optionally a user ID provided to him by the service when registering to the service.

The seller 410 requests confirmation 404 from the service 420.

The service 420 optionally communicates 422 the request to a payment company 430 (if applicable) and receives 424 confirmation or denial in return. The service 420 confirms or denies the transaction 405 to the seller 410.

Alternatively, the user may be prompted to provide his session ID and/or user ID to the smartphone application's GUI, whereby a confirmation code is displayed which is then provided to the seller 410.

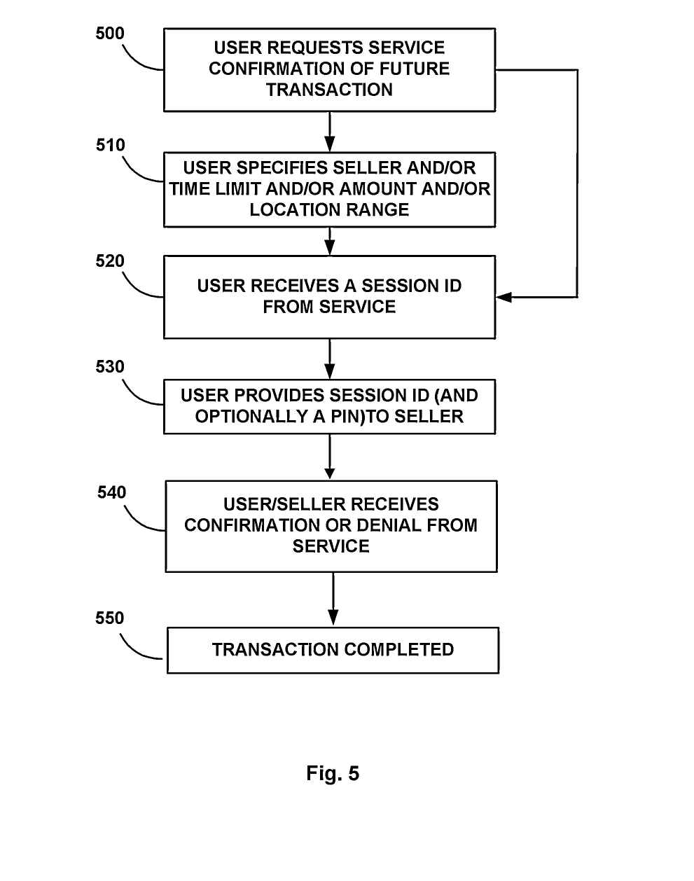

FIG. 5 is a flowchart showing the various steps taken by the user (buyer) according to an embodiment of the present invention.

In step 500 the user requests from the service confirmation for a future unknown/known transaction(s). The user may specify (step 510) a seller and/or a time limit and/or a fixed or maximal amount (possibly with the option to deviate by a prefixed percent) and/or a location range for the transaction. If a seller is specified, the requested transaction will be associated with a unique seller ID. If the user is presently registering to the service, he may preferably be supplied with a user ID (such as but not limited to: PIN—Personal Identification Number) by the service or asked to supply biometric identification means (e.g. voice signature), to prevent fraudulent use of his payment means.

In step 520, if the service approves the request, the user may receive a session ID from the service.

In step 530, which may take place at a later time, the user provides his session ID and optionally his user ID to a seller, which may have been specified in the original request (step 510).

In step 540 after the seller has communicated the request to the service, the user receives from the seller a confirmation or denial of the request and the transaction is completed (step 550).

If an amount had been specified in the original allocation request, the transaction amount may be the full amount allocated or part of it, depending on the original user request and service confirmation.

Alternatively, the user may provide his session ID or user ID to his smartphone application's GUI, whereby a confirmation code is displayed which is then provided to the seller.

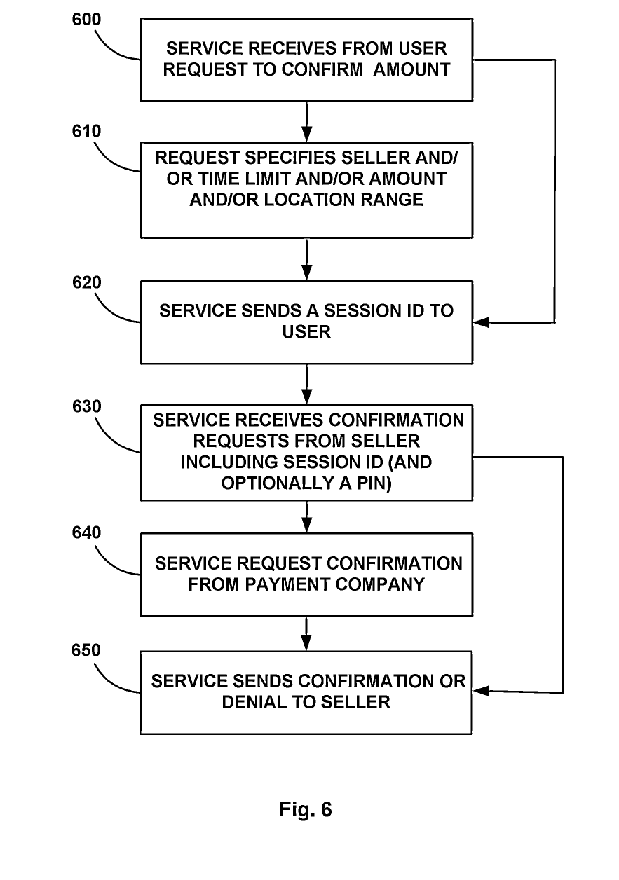

FIG. 6 is a flowchart showing the various steps taken by the service according to an embodiment of the present invention.

In step 600 the service receives from the user a request to confirm one or more future unknown/known transaction. The request may specify (step 610) a seller and/or a time limit and/or a fixed or maximal amount (possibly with the option to deviate to a prefixed percent) and/or a location range for the transaction.

In step 620, if the service approves the request, it opens a payment session including an expiration date (if applicable), the requested amount (maximum or substantially fixed if applicable) and a seller ID (if applicable). The service sends a session ID to the user.

Alternatively, the service may provide the user with a user ID to be used in any future transaction.

In step 630, which may take place at a later time, the service receives a confirmation request from a seller, including the seller ID (optional), the user's session ID (and optionally a user ID) and the amount of the transaction and in step 640 the service requests confirmation from a payment company (if applicable). The service sends a confirmation or denial of the transaction to the seller.

Alternatively, the service receives a session ID or user ID from the user's smartphone application and returns a confirmation code to be presented to the seller.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

1. A method of pre-allocating amounts for payment transactions comprising:
receiving by a payment service server a registration request to said service from a user's communication device, said registration request comprising information related to said user's payment means;
allocating by said payment service a user ID to said user's communication device;
receiving by said payment service server a request for allocating a sum of money from said user's communication device, said request comprising said user ID;
checking by said payment service server if the sum may be allocated to the user;
allocating by said payment service server the sum of money to the user; and
sending by said payment service server a session ID to the user.

2. The method of claim 1, wherein said request for allocating comprises a seller ID.

3. The method of claim 1, wherein said request for allocating comprises a time limit.

4. The method of claim 1, wherein said request for allocating comprises an indication of whether said sum of money is maximum or substantially fixed.

5. The method of claim 1, wherein said request for allocating comprises a location range.

6. The method of claim 1, wherein said user ID comprises a PIN.

7. The method of claim 1, wherein said user ID comprises biometric identification.

8. A method of selling, comprising:
receiving by a seller a session ID from a buyer's communication device, said session ID representing at least a sum of money;
requesting by said seller confirmation for said session ID from a payment service's server, said request comprising at least said sum of money; and
receiving by said seller said confirmation from said payment service's server.

9. The method of claim 8, wherein said session ID comprises a seller ID.

10. The method of claim 8, wherein said session ID comprises a time limit.

11. The method of claim 8, wherein said session ID comprises an indication of whether said sum of money is maximum or substantially fixed.

12. The method of claim 8, additionally comprising receiving by said seller a user ID from said buyer and wherein said requesting confirmation additionally comprises said user ID.

13. The method of claim 12, wherein said user ID comprises a PIN.

14. The method of claim 12, wherein said user ID comprises biometric identification.

15. The method of claim 8, additionally comprising receiving a location range from said buyer and wherein said requesting confirmation additionally comprises said location range.

16. A method of purchasing, comprising:
sending by a user's communication device a registration request to a payment service server, said registration request comprising information related to said user's payment means;
allocating by said payment service's server a user ID to said user's communication device;
sending by said user's communication device to said payment service server a request for allocating a sum of money, said request comprising said user ID;
receiving by said user's communication device a confirmation for said allocation request, said confirmation comprising a session ID representing at least a sum of money;
supplying said session ID to a seller;
requesting by said seller confirmation for said session ID from said payment service server, said request comprising at least a sum of money and an ID of said seller; and
receiving by said seller from said payment service server said confirmation.

17. The method of claim 16, wherein said session ID comprises a seller ID.

18. The method of claim 16, wherein said session ID comprises a time limit.

19. The method of claim 16, wherein said session ID comprises an indication of whether said sum of money is maximum or substantially fixed.

20. The method of claim 16, wherein said user ID comprises a PIN.

21. The method of claim 16, wherein said user ID comprises biometric identification.

22. The method of claim 16, additionally comprising supplying a location range to said seller.

23. A system for pre-allocating amounts for payment transactions comprising:
a payment service company comprising:
a service server;
first communication means configured to receive a registration request from at least one user, said registration request comprising information related to said user's payment means;
said server configured to allocate a user ID to said at least one user;
said first communication means further configured for receiving a request for allocation of a sum of money from a user and for transmitting a confirmation to said user, including a session ID;
at least one user comprising second communication means configured to communicate said request for registration and said request for allocating a sum of money to said payment company; and
at least one seller comprising third communication means configured to communicate said session ID and at least a sum of money to said payment service server;
said first communication means additionally configured to communicate a confirmation to said seller.

24. The system of claim 23, wherein said first and third communication means comprise at least one of a computer, a line telephone and a cellular phone.

25. The system of claim 23, wherein said second communication means comprise at least one of a computer/terminal/POS, a line telephone and a cellular phone.

26. The system of claim 23, wherein at least one of said first, second and third communication means are line communication means.

27. The system of claim 23, wherein at least one of said first, second and third communication means are wireless communication means.

28. The system of claim 23, wherein said third communication means are additionally configured to communicate at least one of a user ID and a location range to said payment company.

29. The system of claim 28, wherein said user ID comprises a PIN.

30. The system of claim 28, wherein said user ID comprises biometric identification.

31. A method of authorizing payment transactions comprising:
receiving by a payment service server a registration request to said service from a user's communication device, said registration request comprising information related to said user's payment means;
allocating by said payment service a user ID to said user's communication device;
receiving by said payment service server a transaction confirmation request from said user's communication device, said transaction confirmation request comprising said user ID and at least a sum of money;
checking by said payment service server if the sum may be allocated to the user; and
sending by said payment service server a confirmation code to said user's communication device.

32. The method of claim 31, wherein said user ID comprises a PIN.

33. The method of claim 31, wherein said user ID comprises biometric identification.

34. A method of selling, comprising:
receiving by a seller a user ID from a buyer's communication device;
requesting by said seller confirmation for said user ID from a payment service's server, said request comprising at least a sum of money; and
receiving by said seller said confirmation from said payment service's server.

35. The method of claim 34, wherein said user ID comprises a PIN.

36. The method of claim 34, wherein said user ID comprises biometric identification.

37. A method of purchasing, comprising:
sending by a user's communication device a registration request to a payment service server, said registration request comprising information related to said user's payment means;
allocating by said payment service's server a user ID to said user's communication device;
sending by said user's communication device to said payment service server a request for allocating a sum of money, said request comprising said user ID;
receiving by said user's communication device a confirmation for said allocation request, said confirmation comprising a confirmation code; and
providing said confirmation code to a seller.

38. The method of claim 37, wherein said user ID comprises a PIN.

39. The method of claim 37, wherein said user ID comprises biometric identification.

40. A system for authorizing payment transactions comprising:
a payment service company comprising:
a service server;
first communication means configured to receive a registration request from at least one user's communication device, said registration request comprising information related to said user's payment means;
said server configured to allocate a user ID to said at least one user; and
said user communication device running an application configured to communicate said user ID and at least a sum of money to said payment service server and receive a payment authorization.

41. The system of claim 40, wherein said user ID comprises a PIN.

42. The system of claim 40, wherein said user ID comprises biometric identification.

43. A computer storage medium tangibly embodying a program of machine-readable instructions executable by a digital processing apparatus to perform the method of claim 1.

44. A computer storage medium tangibly embodying a program of machine-readable instructions executable by a digital processing apparatus to perform the method of claim 8.

45. A computer storage medium tangibly embodying a program of machine-readable instructions executable by a digital processing apparatus to perform the method of claim 16.

46. A computer storage medium tangibly embodying a program of machine-readable instructions executable by a digital processing apparatus to perform the method of claim 31.

47. A computer storage medium tangibly embodying a program of machine-readable instructions executable by a digital processing apparatus to perform the method of claim 34.

48. A computer storage medium tangibly embodying a program of machine-readable instructions executable by a digital processing apparatus to perform the method of claim 37.
